(19) United States
(12) Patent Application Publication
(10) Pub. No.: US 2009/0311509 A1
(43) Pub. Date: Dec. 17, 2009

(54) Foam product having an accessory and method of making

(76) Inventor: Tzong In Yeh, Fremont, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,953

(22) Filed: Jun. 12, 2008

(51) Int. Cl. B32B 3/26; B32B 37/14

(52) U.S. Cl. 428/317.1; 156/78

(57) ABSTRACT

A foam product embedded with an accessory and a method of making the same are disclosed. The foam product includes a foam body, the accessory and an adhesive member. The foam body is composed of a plurality of expanded foam beads bonded with one another. The accessory is fully or partly embedded in the foam body. The adhesive member is interposed between the foam body and the accessory. In particular, the adhesive member has branches-penetrating into gaps among the expanded foam beads that surround the accessory.

### BACKGROUND OF INVENTION

1. Field of Invention

This invention relates to a foam product embedded with an accessory and a method of making the same, and more particularly to a technique which enables establishing strong connection between an accessory and a foam body.

2. Related Prior Art

FIG. 5 illustrates a conventional foam body 5 embedded with an accessory 6. The foam body 5 defines a through hole 50. The accessory 6 is composed of a male fastener 60 and a female fastener 61. As shown, both the male and female fasteners 60, 61 are received in the through hole 50 and engage with each other. In this manner, the accessory 6 seems to be securely embedded in the foam body 5.

However, since the accessory 6 is merely received with its exterior surfaces not adhered to the foam body 5 and the accessory 6 is often under a heavy load while in use, the through hole 50 in which the accessory 6 is situated may easily be enlarged bit by bit. The enlarged through hole 50 causes the accessory 6 to be prone to movement within the through hole 50.

### SUMMARY OF INVENTION

The invention relates to a method for producing a foam product, wherein a plurality of foam beads together with an accessory coated with thermoplastic adhesive are placed in a cavity of a mold and then be heated to produce the foam product embedded with the accessory.

By using the method, the foam product is formed to include a foam body, the accessory embedded in the foam body and an adhesive member strongly connecting the foam body and the accessory. The foam body is formed of the plurality of expanded foam beads bonded with one another. The accessory is fully or partly embedded in the foam body. The adhesive member made of the thermoplastic adhesive, shaped like fibrous roots, is interposed between the foam body and the accessory. In particular, the adhesive member has branches penetrating into gaps among the associated expanded foam beads that surround the accessory. Hence the bonding strength between the foam body and the accessory are greatly improved.

The present invention and the advantages thereof will become more apparent upon consideration of the following detailed description when taken in conjunction with the accompanying drawings.

### BRIEF DESCRIPTION OF DRAWINGS

FIG. 1 is a perspective view of an accessory coated with thermoplastic adhesive in accordance with the preferred embodiment of the invention;

FIG. 2 is a cross section illustrating that a plurality of foam beads and the coated accessory of FIG. 1 are placed in a cavity of a mold;

FIG. 3 is similar to FIG. 2, illustrating the foam beads are expanded under heat treatment;

FIG. 4 is similar to FIG. 3 except that the mold has been removed; and

FIG. 5 is a conventional foam product.

### DETAILED DESCRIPTION OF EMBODIMENTS

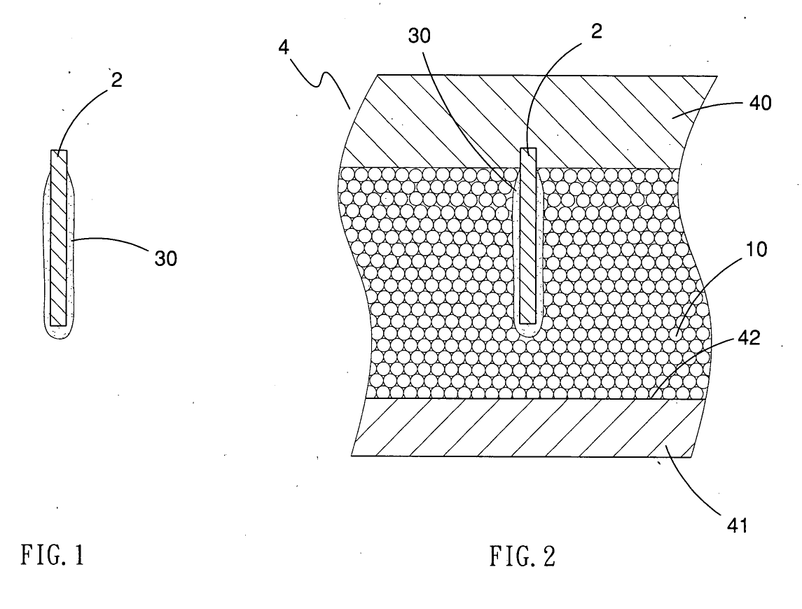

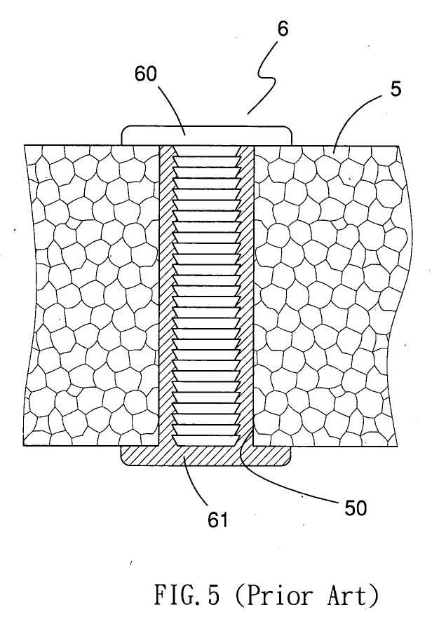

In accordance with the preferred embodiment of the invention, a method of making a foam product in which an accessory 2 is securely embedded in a foam body 1 is illustrated in FIGS. 1-5 as including the steps described below.

As shown in FIG. 1, the first step in the method is to have the accessory 2 coated with thermoplastic adhesive 30, such as hot melt adhesive or heat seal adhesive. Thermoplastic adhesive 30 remains the state of solid under room temperature, melts into viscous liquid when being heated up to some certain degree, and transforms back into its original solid state with extremely strong viscosity. In this preferred embodiment, the thermoplastic adhesive 30 is hot melt adhesive, which is strongly bonded to the accessory 2. The accessory 2 may be made of metal, wood, plastic, fiber glass, carbon fiber or other composite materials. Take a surfboard for instance, the accessory 2 can be served as a fin or a handle partly mounted on a surface of the surfboard or as a stringer fully embedded inside the surfboard.

The next step in the process, shown in FIG. 2, is to place and position the coated accessory 2 in a cavity 42 of a mold 4 and then introduce a plurality foam beads 10 in the cavity 42. The mold 4 is composed of an upper die half 40 and a lower die half 41, that co-define the cavity 42. The foam beads 10 are pre-foamed particles made of a material selected from the group consisting of polypropylene (PP), polyethylene (PE), polystyrene (PS), a PE/PS blend (PO), or the like. It should be noted that the cavity 42 should be roughly filled up with those foam beads 10 although there are still some gaps left among the foam beads 10 and also between the foam beads 10 and inner walls of the mold 4. Nevertheless, the foam beads 10 must be sufficient in quantity to be formed into the foam body 1 after the molding process, as will be described hereinafter.

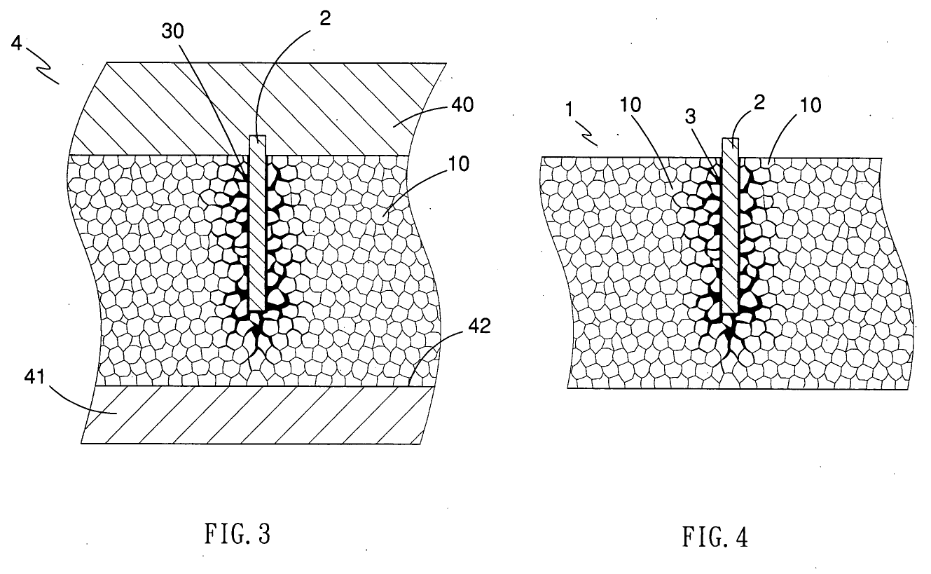

Once having the accessory 2 and the foam beads 10 in place, the mold 4 is heated. Under the heat treatment, the foam beads 10 are expanded into the foam body 1 with a shape corresponding to that of the cavity 42 of the mold 4. Particularly, the hot melt adhesive 30 melts and penetrates into the gaps of the expanded foam beads 10, whereby adhering the accessory 2 to the foam body 1, as depicted in FIG. 3. More specifically, during the heating process, a jet of stream of high-temperature and high-pressure fluid is injected into the mold cavity 42. Under such circumstances, the foam beads 10 are expanded in volume with their surfaces melting. On the other hand, the hot melt adhesive 30 melts into viscous liquid and is driven by the steam to spread through everywhere. Note that the die pressure should be controlled not to break the mold 4 in case it may happen due to the high steam pressure as well as the force generated by the expanded foam beads 10.

After the foaming process, the foam product including the foam body 1 and the accessory 2 is formed and taken out of the mold 4, as shown in FIG. 4. As can be understood, the foam body 1 is actually formed from the pre-foamed or expanded foam beads 10 that are tightly bonded with one another. In particular, an adhesive member 3 is generated between the foam body 1 and the accessory 2. The adhesive member 3 is formed from the hot melt adhesive 30 which transforms back into the current original solid state. As shown in FIG. 4, the adhesive member 3, shaped like fibrous roots, has branches penetrating into the gaps among associated ones of the expanded foam beads 10 that surround the accessory 2 in virtue of the aforementioned high pressure.

The foregoing description is for purposes of illustration only and is not intended to limit the scope of the protection accorded this invention. The scope of protection is to be measured by the following claims, which should be interpreted as broadly as the inventive contribution permits.

The invention claimed is:

1. A method of making a foam product embedded with an accessory, comprising the steps of:
coating thermoplastic adhesive on a surface of the accessory;
placing the coated accessory in a cavity of a mold;
introducing a plurality of foam beads into the cavity of the mold; and
heating the mold in order to expand the foam beads into a foam body with a shape corresponding to that of the cavity, to melt the thermoplastic adhesive, and to enable the thermoplastic adhesive penetrating into gaps of the expanded foam beads whereby adhering the accessory to the foam body.

2. The method of claim 1, wherein the thermoplastic adhesive is hot melt adhesive.

3. A foam product comprising:
a foam body composed of a plurality of expanded foam beads bonded with one another;
an accessory fully or partly embedded in the foam body; and
an adhesive member interposed between the foam body and the accessory, wherein the adhesive member has branches penetrating into gaps among associated ones of the expanded foam beads that surround the accessory.

4. The foam product of claim 3, wherein the adhesive member is made of holt melt adhesive.

5. A foam product comprising:
a foam body composed of a plurality of expanded foam beads bonded with one another;
an accessory fully or partly embedded in the foam body; and
an adhesive member made of hot melt adhesive and interposed between the foam body and the accessory.
